(19) United States
(12) Patent Application Publication
(10) Pub. No.: US 2026/0241312 A1
(43) Pub. Date: Aug. 20, 2026

(54) SPLIT RESIN BED, LOW PRESSURE DROP, AND REPLACEABLE CARTRIDGE DEIONIZATION FILTER

(71) Applicant: Atmus Filtration Inc., Nashville, TN (US)

(72) Inventors: Dhananjay Kumar Singh, Pune (IN); Shantanu Sanjay Ghatnekar, Pune (IN); Balasaheb Mahadev Bhittam, Kolhapur (IN)

(73) Assignees: Cummins Filtration Inc., Nashville, TN (US); Atmus Filtration Inc., Nashville, TN (US)

(21) Appl. No.: 18/876,840

(22) PCT Filed: Jun. 26, 2023
(86) PCT No.: PCT/US2023/026205

§ 371 Date: Dec. 19, 2024

(30) Foreign Application Priority Data
Jun. 27, 2022 (IN) 202241036733

(51) Int. Cl. B01D 29/23; B01D 35/00; B01D 35/02

(52) U.S. Cl. CPC B01D 29/23; B01D 35/005; B01D 35/02; B01D 2201/16; B01D 2201/29; B01D 2259/45

(57) ABSTRACT

A filtration system for filtering a fluid is described herein. The filtration system includes a filter cartridge. The filter cartridge includes a center tube, a first resin bed assembly, a second resin bed assembly, and a bed separator. The center tube includes a first inlet. The first resin bed assembly is disposed at the first inlet. The first resin bed assembly includes a resin bed and a first outer cover. The resin bed is disposed within the first outer cover The first outer cover defines a first outlet. The bed separator is disposed between the first resin bed assembly and the second resin bed assembly.

### CROSS-REFERENCE TO RELATED PATENT APPLICATIONS

This Application is a National Phase Application based on PCT Application No. PCT/US 2023/026205, filed Jun. 26, 2023, which claims priority to Indian Provisional Application No. 202241036733, filed Jun. 27, 2022. The contents of these applications are incorporated herein by reference in their entirety.

### FIELD

The present invention relates generally to chemical filtration systems for use in chemically filtering fluids, such as coolant or other fluids.

### BACKGROUND

In a fuel cell system or similar system, ions from various sources build up within a coolant fluid. When the ions build up in the coolant fluid, the ions change (e.g., increase the conductivity of the fluid, which may be detrimental for an electrically charged fuel cell system or similar system. For example, high fluid conductivity may degrade the performance of the fuel cell system and, if left unchecked, may cause the fuel cell system to fail by short circuit. Ion exchange resins-based deionizing (“DI”) filters are used to remove ions from the coolant fluid. More specifically, DI filters are used to regulate the conductivity of the coolant fluid by chemically neutralizing free ions. In some DI filtration systems, performance parameters such as exchange capacity, efficiency, and pressure drop are inversely related. For example, a DI filtration system may have a good exchange capacity but cause a large pressure change across the DI filter. Additionally, tunneling formation and resin migration are other phenomenon which may cause non-uniform flow distribution and/or underutilization of the resin thereby reducing exchange capacity and efficiency of a DI filtration system. Further, in some DI filtration systems, the resin may not be fully utilized. The low utilization of the resin may result in unused resin being replaced when a filter cartridge is replaced.

### SUMMARY

One embodiment relates to a filter cartridge. The filter cartridge includes a center tube, a first resin bed assembly, a second resin bed assembly, and a bed separator. The center tube includes a first inlet. The first resin bed assembly is disposed at the first inlet. The first resin bed assembly includes a resin bed and a first outer cover. The resin bed is disposed within the first outer cover. The first outer cover defines a first outlet. The bed separator is disposed between the first resin bed assembly and the second resin bed assembly.

Another embodiment relates to a filtration system. The filtration system includes a filter body and a filter cartridge. The filter body includes a first port and a second port. The filter cartridge includes a center tube, a first resin bed assembly, a second resin bed assembly, and a bed separator. The center tube includes a first inlet. The first resin bed assembly is disposed at the first inlet. The first resin bed assembly includes a resin bed and a first outer cover. The resin bed is disposed within the first outer cover. The first outer cover defines a first outlet. The bed separator is disposed between the first resin bed assembly and the second resin bed assembly.

Another embodiment relates to a filter cartridge. The filter cartridge includes a center tube, a first resin bed assembly, a second resin bed assembly, a third resin bed assembly, a first bed separator, a second bed separator, and a cover. The center tube includes a first inlet, a second inlet, and a third inlet. The first resin bed assembly is disposed at the first inlet. The second resin bed assembly disposed at the second inlet. The third resin bed assembly is disposed at the third inlet. The first bed separator is disposed between the first resin bed assembly and the second resin bed assembly. The second bed separator is disposed between the second resin bed assembly and the third resin bed assembly. The cover is disposed at the third resin bed assembly such that the third resin bed assembly is between the cover and the second bed separator.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a side sectional view showing a filtration system, according to an example embodiment.

FIG. 2A is a perspective view of the filtration system of FIG. 1, shown in a disassembled state.

FIG. 2B is a perspective view of a cartridge assembly for use in the filtration system of FIG. 1, shown in a disassembled state.

FIG. 3 is a schematic diagram of coolant system, according to an example embodiment.

### DETAILED DESCRIPTION

Referring to the Figures generally, various embodiments disclosed herein relate to a filtration system. More specifically, the various embodiments disclosed herein relate to a fluid deionizing (DI) system. The DI filtration system includes an improved, replaceable deionization cartridge. The DI cartridge includes ion exchange resins for removing organic, inorganic, metallic and nonmetallic ions from the coolant of a fuel cell system or a similar system which requires a low conductivity solution. The cartridge design includes multiple resin beds where the individual height and flow area can be adjusted to meet a desired pressure change across the resin bed. The resin beds are arranged in such a way that the flow is split within the cartridge assembly creating parallel flow paths, thereby reducing the overall pressure drop across the cartridge for the same amount of resin compared to a conventional axial flow cylindrical DI filter. The resin beds and the fluid flow are synchronized such that tunneling formation and resin bypass are minimized, and such that the effect of resin migration on exchange capacity is mitigated. More specifically, resin housing ports are positioned such that a direction of fluid flowing through the resin housing is aligned to minimize tunneling formation, bypass, and mitigate the effect of resin migration on exchange capacity. As used herein, “tunneling formation” refers to the formation of “tunnels” or passages in the resin bed. “Bypass” refers to when a fluid bypasses at least a portion of a resin bed, reducing the utilization of the resin bed. “Resin migration” refers to when the resin bed is caused to move or compress (e.g., due to fluid pressure), reducing the utilization of the resin bed.

Various embodiments disclosed herein provide an improved DI filter system for deionizing a fluid, such as coolant. Neutralizing ions within a fluid may improve the life of the fluid and downstream devices, such as a fuel cell. More specifically, various embodiments described herein relate to an improved resin-based DI filtration system that may advantageously (i) reduce the pressure change of the fluid passing through the DI filter and (ii) increase utilization of the resin. Increasing utilization of the resin capacity before discarding or regenerating the resins may reduce operating costs of the DI filtration system. Thus, various embodiments disclosed herein may provide an improved filter system that increases or maximizes the capacity and utilization of ion exchange resins with the added benefit of low pressure drop compared to various conventional ion filter systems. Various embodiments disclosed herein further provide an improved DI filter cartridge which allows for easier cartridge replacement. More specifically, the replaceable cartridge can be easily removed and replaced with a fresh cartridge without the need to remove the inlet and outlet tubes/pipes.

The embodiments shown and described in further detail herein relate to an inside-out flow design for a filtration system. It should be understood that the embodiments described herein may be utilized in other filtration system arrangements. For example, the embodiments described herein may be utilized in an outside-in flow design and/or any other type of filtration systems. Additionally, the filtration system may include more or fewer components than as shown in the Figures. Accordingly, references to various components being within, downstream, exterior, upstream, and the like are relative to the embodiments shown in Figures, and it should be understood that other embodiments, such as an outside-in flow design for a filtration system, may have the same or similar components provided in a different arrangement.

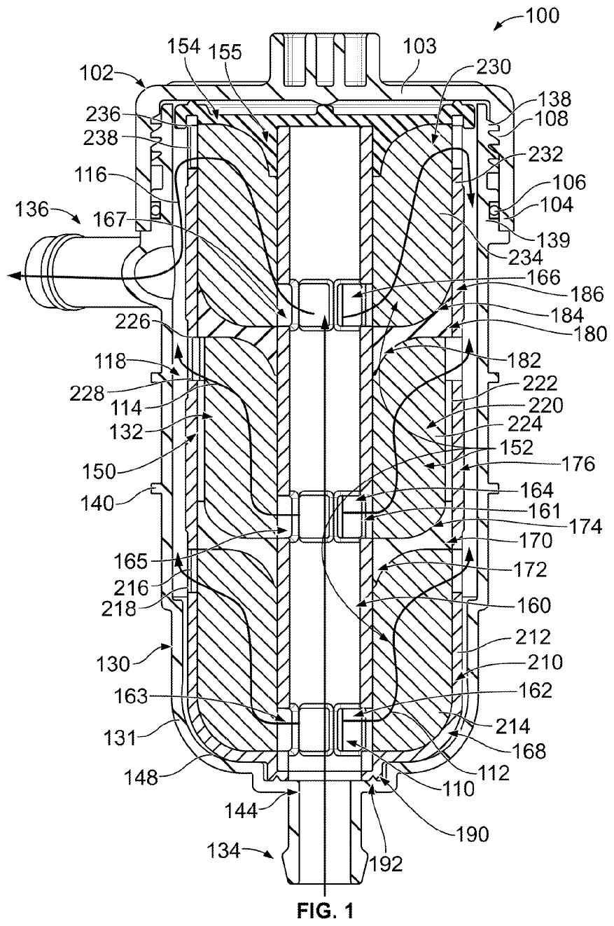

Now referring to FIG. 1, a side sectional view of a filtration system 100 is shown, according to an example embodiment. The filtration system 100 is configured to receive an ionized fluid (e.g., coolant, etc.), filter the fluid by a deionizing process, and provide the deionized fluid to a downstream device, such as a fuel cell stack. As shown, the filtration system 100 includes a filter head 102, a filter housing 130, and a cartridge assembly 150. It should be understood that the filtration system 100 may include more or fewer components than as shown in FIG. 1.

The filter head 102 includes a filter head body 103. The filter head body 103 defines a filter head sealing surface 104. The filter head 102 also includes one or more filter head threads 108 that enable coupling the filter head 102 to the filter housing 130. As shown in FIG. 1, the filter head threads 108 are inward facing threads (e.g., female threads). It should be understood that, in other embodiments, the filter head 102 may have a different design or configuration than as shown in FIG. 1.

The filter housing 130 includes a filter body or shell 131 that defines an internal volume 132. The shell 131 includes one or more shell threads 138 and a shell sealing surface 139. The shell threads 138 enable the coupling of the filter housing 130 to the filter head 102. As shown in FIG. 1, the shell threads 138 are outward facing threads (e.g., male threads) that are received by the filter head threads 108 of the filter head 102. The shell sealing surface 139 may define a channel that extends around an outer circumference of the shell 131. The channel receives a sealing member 106 therein. When the filter housing 130 is coupled to the filter head 102 (e.g., by the shell threads 138 engaging the filter head threads 108), the sealing member 106 is disposed between the filter head sealing surface 104 and the shell sealing surface 139 such that the sealing member 106 contacts the filter head sealing surface 104 and the shell sealing surface 139 forming a radial seal therebetween.

The filter housing 130 also includes an inlet port 134 and an outlet port 136. The inlet port 134 is in fluid receiving communication with an upstream device, such as a fluid pump.

The inlet port 134 is in fluid providing communication with an axial fluid conduit 110. In the embodiment shown in FIG. 1, the inlet port 134 is disposed at the bottom of the shell 131 and axially aligned with the axial fluid conduit 110. The outlet port 136 is in fluid receiving communication with the cartridge assembly 150. The outlet port 136 is in fluid providing communication with a downstream device, such as a fuel cell stack. In the embodiment shown in FIG. 1, the outlet port 136 is disposed on a side of the shell 131 and extends radially outward.

The filter housing 130 also includes a mounting groove 140. The mounting groove is positioned on the exterior of the shell 131. The mounting groove 140 receives a mounting clamp therein (not shown) such that the filter housing 130 is coupled to the mounting clamp. In other embodiments, the filter housing 130 may include other mounting features that correspond to different mounting designs.

The cartridge assembly 150 is configured to deionize the fluid (e.g., by removing ions). In some embodiments, the cartridge assembly 150 is removably coupled to the filter housing 130 such that the cartridge assembly 150 may be removed and/or replaced. When the filtration system 100 is in an assembled state, the cartridge assembly 150 is at least partially contained within the filter head 102 and/or the filter housing 130.

A gap is defined between the cartridge assembly 150 and the filter housing 130. More specifically, the gap is defined by a radially outer surface of the cartridge assembly 150 and a radially inner surface of the filter housing 130. The gap defines an outlet channel 118. The outlet channel 118 is in fluid receiving communication with the cartridge assembly 150 and fluid providing communication with the outlet port 136.

The cartridge assembly 150 includes a plurality of resin bed assemblies 152, a top cover 154, a plurality of bed separators 156, and a center tube 160. The center tube 160 is a hollow tube that extends axially from the inlet 134 towards the filter head 102. The center tube 160 defines the axial conduit 110. The center tube 160 includes a plurality of inlet ports 161. As described in more detail herein, each of the inlet ports 161 are in fluid receiving communication with the axial conduit 110 and fluid providing communication with at least one of the resin bed assemblies 152. In some embodiments, a wire screen is positioned over the inlet ports 161 such that the fluid flowing through the inlet ports 161 flows through the wire screen. The wire screen has openings that are at least 50% smaller than the smallest resin bead size of the resin bed assemblies 152.

In the embodiment depicted in FIG. 1, the plurality of resin bed assemblies 152 includes a first resin bed assembly 210, a second resin bed assembly 220, and a third resin bed assembly 230. It should be understood that the filtration system 100 may include more or fewer resin bed assemblies than as shown in FIG. 1. The first resin bed assembly 210 includes a first resin bed 214. The first resin bed 214 is in fluid receiving communication with a first set of inlet ports 162 of the plurality of inlet ports 161. The first set of inlet ports 162 are positioned at a first axial end of the first resin bed 214. A first inlet screen 163 (e.g., a wire screen) may be positioned at the first set of inlet ports 162 such that the fluid flowing through the first set of inlet ports 162 flows through the first inlet screen 163. The first resin bed 214 is packed within an outer cover shown as a first outer cover 212. The first outer cover 212 extends around the periphery of the first resin bed 214 such that the first resin bed 214 is radially within the first outer cover 212. The first outer cover 212 at least partially defines the radially outer surface of the cartridge assembly 150. The first outer cover 212 includes a first outlet port 216 that is in fluid receiving communication with the first resin bed 214 and fluid providing communication with the outlet channel 118. The first outlet port 216 (which may comprise multiple first outlet ports 216 in various embodiments) is positioned at a second axial end of the first resin bed 214, separated by a distance with respect to first set of inlet ports 162. The distance of offset is equal to a height of the first resin bed 214. In some embodiments, a first outlet wire screen 218 is positioned over the first outlet port 216 such that the fluid flowing through the first outlet port 216 flows through the first outlet wire screen 218. The first outlet wire screen 218 has opening that are at least 50% smaller than the smallest resin bead size of the first resin bed 214.

The second resin bed assembly 220 includes a second resin bed 224. The second resin bed 224 is in fluid receiving communication with a second set of inlet ports 164 of the plurality of inlet ports 161. The second set of inlet ports 164 are positioned at a first axial end of the second resin bed 224. A second inlet screen 165 may be positioned at the second set of inlet ports 164 such that the fluid flowing through the second set of inlet ports 164 flows through the second inlet screen 165. The second resin bed 224 is packed within an outer cover shown as a second outer cover 222. The second outer cover 222 extends around the periphery of the second resin bed 224 such that the second resin bed 224 is radially within the second outer cover 222. The second outer cover 222 at least partially defines the radially outer surface of the cartridge assembly 150. The second outer cover 222 includes a second outlet port 226 that is in fluid receiving communication with the second resin bed 224 and fluid providing communication with the outlet channel 118. The second outlet port 226 (which may comprise multiple second outlet ports 226 in various embodiments) is positioned at a second axial end of the second resin bed 224, separated by a distance with respect to second set of inlet ports 164. The distance of offset is equal to a height of the second resin bed 224. In some embodiments, a second outlet wire screen 228 is positioned over the second outlet port 226 such that the fluid flowing through the second outlet port 226 flows through the second outlet wire screen 228. The second outlet wire screen 228 has opening that are at least 50% smaller than the smallest resin bead size of the second resin bed 224.

The third resin bed assembly 230 includes a third resin bed 234. The third resin bed 234 is in fluid receiving communication with a third set of inlet ports 166 of the plurality of inlet ports 161. The third set of inlet ports 166 are positioned at a first axial end of the third resin bed 234. A third inlet screen 167 may be positioned at the third set of inlet ports 166 such that the fluid flowing through the third set of inlet ports 166 flows through the third inlet screen 167.

The third resin bed 234 is packed within an outer cover shown as a third outer cover 232. The third outer cover 232 extends around the periphery of the third resin bed 234 such that the third resin bed 234 is radially within the third outer cover 232. The third outer cover 232 at least partially defines the radially outer surface of the cartridge assembly 150. The third outer cover 232 includes a third outlet port 236 that in in fluid receiving communication with the third resin bed 234 and fluid providing communication with the outlet channel 118. The third outlet port 236 (which may comprise multiple third outlet ports 236 in various embodiments) is positioned at a second axial end of the third resin bed 234, separated by a distance with respect to third set of inlet ports 166. The distance of offset is equal to a height of the third resin bed 234. In some embodiments, a third outlet wire screen 238 is positioned over the third outlet port 236 such that the fluid flowing through the third outlet port 236 flows through the third outlet wire screen 238. The third outlet wire screen 238 has opening that are at least 50% smaller than the smallest resin bead size of the third resin bed 234.

In the embodiment shown in FIG. 1, each of the first resin bed 214, the second resin bed 224, and the third resin bed 234 are substantially equal in size. Also, in the embodiment of FIG. 1, each of the first set of inlet ports 162, the second set of inlet ports 164, and the third set of inlet ports 166 are spaced at equal intervals that match the size of the first resin bed 214, the second resin bed 224, and the third resin bed 234.

In some embodiments, the first outer cover 212 includes a curved portion 168 that extends radially inwards towards the center tube 160. The curved portion 168 is curved such that when the fluid flowing through the first resin bed 214 contacts the curved portion 168, the fluid is directed to flow away from the first set of inlet ports 162 and axially towards the first outlet port 216. The flow direction caused by the curved portion 168 enables the first resin bed 214 to be more fully utilized.

The plurality of bed separators 156 separate the resin bed assemblies 152 from each other. As shown in FIG. 1, a first bed separator 170 separates the first resin bed 214 from the second resin bed 224. In particular, the first bed separator 170 is positioned between the first outlet port 216 and the second set of inlet ports 164 such that the first resin bed 214 is packed between the curved portion 168 and the first bed separator 170. More specifically, the first resin bed 214 is positioned axially between the curved portion 168 and the first bed separator 170.

The first bed separator 170 has projections at center and outer edges of the first bed separator 170 shown as a first projection 172 and a second projection 174. The first projection 172 is positioned at a center portion of the first bed separator 170 and extends in a first axial direction, towards first resin bed 214. The first projection 172 is curved such that, when the fluid flowing through the first resin bed 214 contacts the first projection 172, the fluid is directed to flow to the first outlet port 216. The flow direction caused by the first projection 172 enables the first resin bed 214 to be more fully utilized. The second projection 174 is positioned at an outer edge of the first bed separator 170 and extends in a second axial direction, towards second resin bed 224. The second projection 174 is curved such that, when the fluid flowing through the second resin bed 224 contacts the second projection 174, the fluid is directed to flow away from the second set of inlet ports 164 and axially towards the second outlet port 226. The flow direction caused by the second projection 174 enables the second resin bed 224 to be more fully utilized.

A second bed separator 180 separates the second resin bed 224 from the third resin bed 234. In particular, the second bed separator 180 is positioned between the second outlet port 226 and the third set of inlet ports 166 such that the second resin bed 224 is packed between the first bed separator 170 and the second bed separator 180. More specifically, the second resin bed 224 is positioned axially between the first bed separator 170 and the second bed separator 180.

The second bed separator 180 has projections at center and outer edges of the second bed separator 180 shown as a first projection 182 and a second projection 184. The first projection 182 is positioned at a center portion of the second bed separator 180 and extends in a first axial direction, towards second resin bed 224. The first projection 182 is curved such that, when the fluid flowing through the second resin bed 224 contacts the first projection 182, the fluid is directed to flow to the second outlet port 226. The flow direction caused by the first projection 182 enables the second resin bed 224 to be more fully utilized. The second projection 184 is positioned at an outer edge of the second bed separator 180 and extends in a second axial direction, towards the third resin bed 234. The second projection 184 is curved such that when the fluid flowing through the third resin bed 234 contacts the second projection 184, the fluid is directed to flow away from the third set of inlet ports 166 and axially towards the third outlet port 236. The flow direction caused by the second projection 184 enables the third resin bed 234 to be more fully utilized.

The top cover 154 is placed between the third outlet port 236 and the filter head 102 such that the third resin bed 234 is packed between the second bed separator 180 and the top cover 154. More specifically, the third resin bed 234 is positioned axially between the second bed separator 180 and the top cover 154. The top cover 154 seals the first resin bed 214, the second resin bed 224, and the third resin bed 234 within the cartridge assembly 150. In some embodiments, the top cover 154 includes a projection at a center of the top cover 154 shown as a first projection 155. The first projection 155 extends in a first axial direction, towards the third resin bed 234. The first projection 155 is curved such that, when the fluid flowing through the third resin bed 234 contacts the first projection 155, the fluid is directed to flow to the third outlet port 236. The flow direction caused by the first projection 155 enables the third resin bed 234 to be more fully utilized.

In some embodiments, the bed separators 156 include axial supports extending away from the bed separators 156 in a first axial direction. For example, the first bed separator 170 includes a set of first supports 176 that extend in a first axial direction towards the second resin bed 224. The set of first supports 176 maintains the distance between the first resin bed 214 and the second resin bed 224. The second bed separator 180 includes a set of second supports 186 that extend in a first axial direction towards the third resin bed 234. The set of second supports 186 maintains the distance between the second resin bed 224 and the third resin bed 234.

In an example operating scenario, a fluid enters the filtration system 100 at the inlet 134. The fluid then flows into the axial conduit 110 and is distributed to the first resin bed 214, the second resin bed 224, and the third resin bed 234 by the center tube 160. In some embodiments, the fluid is distributed equally to each of the first resin bed 214, the second resin bed 224, and the third resin bed 234. A first fluid flow path 112 is defined by the first resin bed 214. The fluid flowing along the first fluid flow path 112 enters the first resin bed 214 radially at the first set of inlets 162, is directed to flow axially through the first resin bed 214 by the curved portion 168, then is directed to flow radially through the first resin bed 214 by the first projection 172 of the first bed separator 170 towards the first outlet port 216, and exits the first resin bed 214 radially through the first outlet port 216. A second fluid flow path 114 is defined by the second resin bed 224. The fluid flowing along the second fluid flow path 114 enters the second resin bed 224 radially at the second set of inlets 164, is directed to flow axially through the second resin bed 224 by the second projection 174 of the first bed separator 170, then is directed to flow radially through the second resin bed 224 by the first projection 182 of the second bed separator 180 towards the second outlet port 226, and exits the second resin bed 224 radially through the second outlet port 226. A third fluid flow path 116 is defined by the third resin bed 234. The fluid flowing along the third fluid flow path 116 enters the third resin bed 234 radially at the third set of inlets 166, is directed to flow axially through the third resin bed 234 by the second projection 184 of the second bed separator 180, then is directed to flow radially through the third resin bed 234 by the first projection 155 of the top cover 154 towards the third outlet port 236, and exits the third resin bed 234 radially through the third outlet port 236. In each of the first flow path 112, the second flow path 114, and the third flow path 116, the fluid may flow from the outlet channel 118 through the outlet 136 and out of the filtration system 100.

As described above, each of the first flow path 112 through the first resin bed 214, the second flow path 114 through the second resin bed 224, and the third flow path 116 through the third resin bed 234, is not purely axial but a combination of axial and radial due to the positioning of the first set of inlet ports 162 relative to the first outlet ports 216, the second set of inlet ports 164 relative to the second outlet port 226, and the third set of inlet ports 166 relative to the third outlet port 236. The radial and axial pressure at the first set of inlet ports 162 pushes the first resin bed 214 towards the first outlet port 216, tightly packing the first resin bed 214 thereby reducing any bypass within the first resin bed 214 and increasing the overall utilization of the first resin bed 214. The radial and axial pressure at the second set of inlet ports 164 pushes the second resin bed 224 towards the second outlet port 226, tightly packing the second resin bed 224 thereby reducing any bypass within the second resin bed 224 and increasing the overall utilization of the second resin bed 224. The radial and axial pressure at the third set of inlet ports 166 pushes the third resin bed 234 towards the third outlet port 236, tightly packing the third resin bed 234 thereby reducing any bypass within the third resin bed 234 and increasing the overall utilization of the third resin bed 234.

The first inlet ports 162 are disposed at the first axial end of the first resin bed 214. The first outlet port(s) 216 are disposed at the second axial end of the first resin bed 214. The first inlet ports 162 are spaced away from first outlet port(s) 216 by the axial length of the first resin bed 214. The second inlet ports 164 are disposed at the first axial end of the second resin bed 224. The second outlet ports 226 are disposed at the second axial end of the second resin bed 224. The second inlet ports 164 are spaced away from second outlet ports 226 by the axial length of the second resin bed 224. The third inlet ports 166 are disposed at the first axial end of the third resin bed 234. The third outlet ports 236 are disposed at the second axial end of the third resin bed 234. The third inlet ports 166 are spaced away from third outlet ports 236 by the axial length of the third resin bed 234. As shown in FIG. 1, each of the first flow path 112 through the first resin bed 214, the second flow path 114 through the second resin bed 224, and the third flow path 116 through the third resin bed 234 extend in an axially upward direction (e.g., against gravity). The axial arrangement of the inlet ports and the outlet ports of the resin beds advantageously reduces the change in pressure across the filtration system 100 and further mitigates against tunnel formation.

In some embodiments, the filtration system 100 includes a bypass valve 144 at the inlet 134. The bypass valve 144 advantageously reduces high pressure pulses, which are caused by overpacking in the first resin bed 214, the second resin bed 224, and the third resin bed 234, thereby increasing the pressure drop and reducing the resin utilization. Resin overpacking occurs when the upstream fluid pressure compresses the resin bed increasing the packing density (or reducing the porosity) of the first resin bed 214, the second resin bed 224, and the third resin bed 234. Increasing the packing density increases the resistance to the fluid flow thereby reducing the amount of flow passing through the first resin bed 214, the second resin bed 224, and the third resin bed 234. In some embodiments, the bypass valve 144 may include at least one of an orifice opening, a spring loaded valve, an umbrella valve, and/or a duckbill valve. In any of these embodiments, the bypass valve 144 may allow fluid to bypass filter cartridge 150 (e.g., the first resin bed 214, the second resin bed 224, and the third resin bed 234) such that the pressure at the inlet 134 is below a maximum threshold (e.g., less than 5 bar, less than 2 bar, etc.) to avoid resin overpacking. In some embodiments, the fluid bypassing the filter cartridge 150 (e.g., the first resin bed 214, the second resin bed 224, and the third resin bed 234) flows along a fourth flow path 148. The fluid flowing along the fourth flow path first flows through the bypass valve 144, then through a gap between the cartridge assembly 150 and the shell 131, then into the outlet channel 118.

The outer surface of the cartridge assembly 150 includes a V-shaped groove 190. As shown in FIG. 1, the groove 190 is a recessed groove that receives a corresponding, projecting V-shaped groove 192 of the shell 131. When the recessed groove 190 engages the projecting groove 192 of the shell 131, the recessed groove 190 and the projecting groove 192 form a seal between the cartridge assembly 150 and the shell 131. A torturous path is formed by a gap between the cartridge assembly 150 and the shell 131. The torturous path allows the fluid to bypass the first resin bed 214, the second resin bed 224, and the third resin bed 234 (e.g., fluid flowing through the bypass valve 144). The sealing of the cartridge assembly 150 and the shell 131 by the recessed groove 190 and the projecting groove 192 reduces the flowrate of the fluid that bypasses the first resin bed 214, the second resin bed 224, and the third resin bed 234.

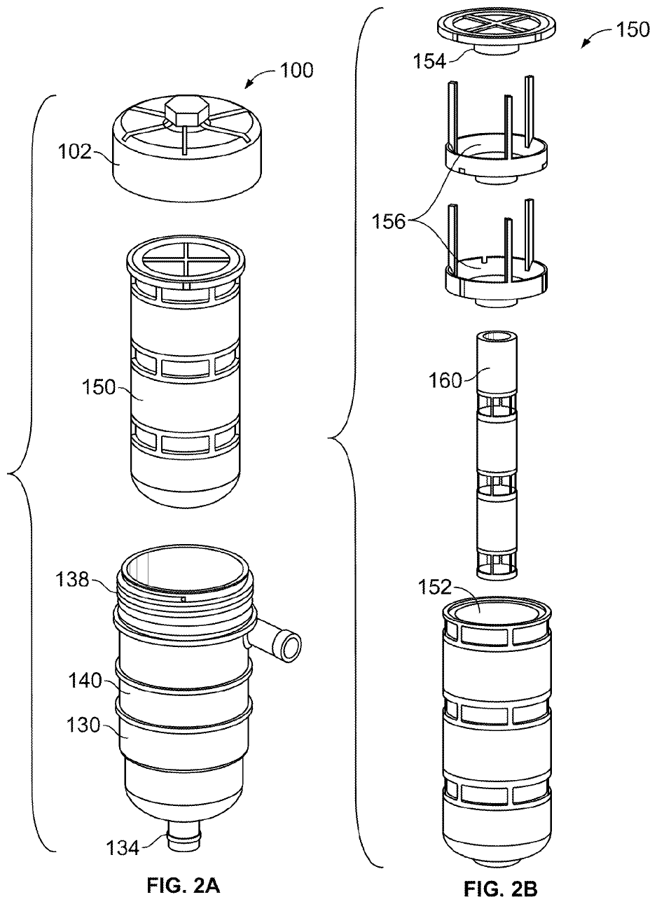

Now referring to FIG. 2A, a perspective view of the filtration system 100 in a disassembled state is shown. As described above, the filtration system includes the filter head 102, the cartridge assembly 150, and the filter housing 130. The filter housing 130 includes the inlet port 134, the outlet port 136, and the shell threads 138.

FIG. 2B shows a perspective view of the cartridge assembly 150 in a disassembled state. As shown, the cartridge assembly 150 includes the plurality of resin bed assemblies 152, the top cover 154, the plurality of bed separators 156, and the center tube 160.

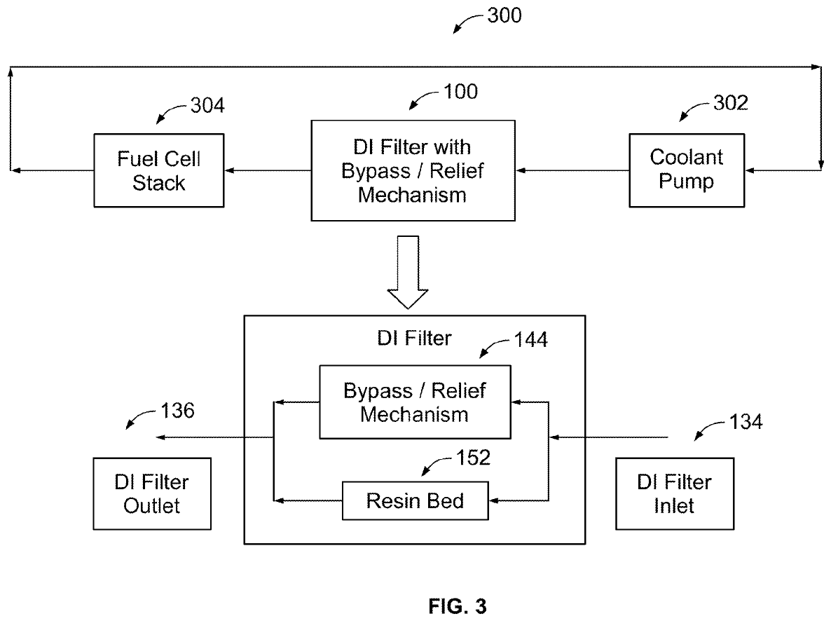

FIG. 3 shows a schematic diagram of coolant system 300, according to an example embodiment. The coolant system 300 includes a coolant pump 302 the filtration system 100, and a fuel cell stack 304. As shown in FIG. 3, a fluid in the coolant system 300 may flow from the coolant pump 302, into the filtration system 100, and into the fuel cell stack 304. The fluid may return to the coolant pump 302 after flowing through the fuel cell stack 304.

As described above, when the fluid flows into the filtration system 100, the fluid enters the filtration system 100 at the inlet 134. The fluid may then flow through at least one of the resin bed assemblies 152, or the fluid may bypass the resin bed assemblies 152 and flow through the bypass valve 144. After flowing through the resin bed assemblies 152 or bypassing the resin bed assemblies 152 and flowing through the bypass valve 144, the fluid exits the filtration system 100 at the outlet 136.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. The term “substantially” as used herein refers to ±10% of the referenced measurement, position, or dimension. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” and the like as used herein mean the joining of two members directly to one another. Such joining may be stationary (e.g., permanent) or moveable (e.g., removable or releasable).

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A filter cartridge comprising:
a center tube comprising a first inlet;
a first resin bed assembly disposed at the first inlet, the first resin bed assembly comprising a resin bed and a first outer cover, the resin bed disposed within the first outer cover, and the first outer cover defining a first outlet;
a second resin bed assembly; and
a bed separator disposed between the first resin bed assembly and the second resin bed assembly such that the bed separator contacts the first resin bed assembly and the second resin bed assembly.

2. The filter cartridge of claim 1, wherein the bed separator comprises:
a first projection extending towards the first resin bed assembly and directing a fluid flowing through the resin bed to the first outlet; and
a second projection extending towards the second resin bed assembly.

3. The filter cartridge of claim 2, wherein the first projection is positioned at a center portion of the bed separator, wherein the first projection is curved such that, when the fluid flowing through the resin bed contacts the first projection, the fluid is directed to flow to the first outlet.

4. The filter cartridge of claim 2, wherein the second projection is positioned at an outer edge of the bed separator, wherein the second projection is curved such that, when the fluid flowing through the second resin bed assembly contacts the second projection, the fluid is directed to flow away from a second inlet of the second resin bed assembly and axially towards a second outlet of the second resin bed assembly.

5. The filter cartridge of claim 1, wherein the first resin bed assembly and the second resin bed assembly define a split resin bed design.

6. The filter cartridge of claim 1, wherein:
the first inlet is disposed at a first axial end of the resin bed; and
the first outlet is disposed at a second axial end of the resin bed, opposite the first axial end, such that a fluid flowing through the first resin bed assembly flows in a first flow direction from the first inlet to the first outlet.

7. The filter cartridge of claim 6, wherein the first outlet separated from the first inlet by a distance, wherein the distance is equal to a height of the resin bed.

8. The filter cartridge of claim 1, further comprising a first inlet screen disposed at the first inlet such that a fluid flowing through the first inlet flows through the first inlet screen.

9. The filter cartridge of claim 8, further comprising a first outlet screen positioned over the first outlet such that the fluid flowing through the first outlet flows through the first outlet screen, wherein the first outlet screen has openings that are at least 50% smaller than a bead size of the resin bed.

10. The filter cartridge of claim 1, wherein the first outer cover includes a curved portion that extends radially inwards towards the center tube, wherein the curved portion is curved such that when a fluid flowing through the resin bed contacts the curved portion, the fluid is directed to flow away from the first inlet and axially towards the first outlet.

11. The filter cartridge of claim 1, wherein the bed separator comprises an axial support extending away from the bed separator towards the second resin bed assembly.

12. A filtration system comprising:
a filter body comprising a first port and a second port; and
a filter cartridge disposed within the filter body, the filter cartridge comprising:
a center tube comprising a first inlet;
a first resin bed assembly disposed at the first inlet, the first resin bed assembly comprising a resin bed and a first outer cover, the resin bed disposed within the first outer cover, and the first outer cover defining a first outlet;
a second resin bed assembly; and
a bed separator disposed between the first resin bed assembly and the second resin bed assembly such that the bed separator contacts the first resin bed assembly and the second resin bed assembly.

13. The filtration system of claim 12, wherein the filter cartridge is removably coupled to the filter body.

14. The filtration system of claim 12, further comprising a bypass valve disposed at the first port, the bypass valve selectively enabling a fluid to bypass the filter cartridge via a gap between the filter cartridge and the filter body.

15. The filtration system of claim 12, wherein the bed separator comprises:
a first projection extending towards the first resin bed assembly and directing a fluid flowing through the resin bed to the first outlet; and
a second projection extending towards the second resin bed assembly.

16. The filtration system of claim 12, wherein the bed separator comprises an axial support extending away from the bed separator towards the second resin bed assembly.

17. The filtration system of claim 12, wherein:
the first inlet is disposed at a first axial end of the resin bed; and
the first outlet is disposed at a second axial end of first resin bed, opposite the first axial end, such that a fluid flowing through the first resin bed assembly flows in a first flow direction from the first inlet to the first outlet.

18. The filtration system of claim 12, wherein the first outer cover includes a curved portion that extends radially inwards towards the center tube, wherein the curved portion is curved such that when a fluid flowing through the resin bed contacts the curved portion, the fluid is directed to flow away from the first inlet and axially towards the first outlet.

19. A filter cartridge comprising:
a center tube comprising a first inlet, a second inlet, and a third inlet;
a first resin bed assembly disposed at the first inlet;
a second resin bed assembly disposed at the second inlet;
a third resin bed assembly disposed at the third inlet;
a first bed separator disposed between the first resin bed assembly and the second resin bed assembly such that the first bed separator contacts the first resin bed assembly and the second resin bed assembly;
a second bed separator disposed between the second resin bed assembly and the third resin bed assembly; and
a cover disposed at the third resin bed assembly such that the third resin bed assembly is between the cover and the second bed separator.

20. The filter cartridge of claim 19, wherein the first bed separator comprises:
a first projection extending towards the first resin bed assembly; and
a second projection extending towards the second resin bed assembly.
